(19) United States
(12) Patent Application Publication
(10) Pub. No.: US 2025/0078657 A1
(43) Pub. Date: Mar. 6, 2025

(54) APPARATUS AND METHOD FOR ASSISTING IN DRIVING VEHICLE IN ENTRANCE AND EXIT LANES

(71) Applicant: HL KLEMOVE CORP., Incheon (KR)

(72) Inventor: Yoonsuk CHOI, Gyeonggi-do (KR)

(21) Appl. No.: 18/657,621

(22) Filed: May 7, 2024

(30) Foreign Application Priority Data
Aug. 29, 2023 (KR) 10-2023-0113919

(51) Int. Cl. G08G 1/0968; G08G 1/01; H04W 4/44

(52) U.S. Cl. CPC G08G 1/096844; G08G 1/0112; G08G 1/0133; G08G 1/0141; G08G 1/0145; H04W 4/44

(57) ABSTRACT

The present disclosure relates to an apparatus for assisting in driving a vehicle in an entrance or exit lane. An apparatus for assisting in driving a vehicle in an entrance or exit lane according to an embodiment of the present disclosure includes an entrance/exit lane determination unit configured to determine whether one or more entrance or exit lanes are present within a predetermined distance in a driving direction of a host vehicle, a driving route setting unit configured to set a driving route of the host vehicle on the basis of traffic information around the entrance or exit lane and driving route information of another vehicle preceding the host vehicle, and a driving route sharing unit configured to share the set driving route of the host vehicle.

### CROSS-REFERENCE TO RELATED APPLICATIONS

This application claims the priority of Korean Patent Application No. 2023-0113919 filed on Aug. 19, 2023, in the Korean Intellectual Property Office, the disclosure of which is incorporated herein by reference.

### BACKGROUND

### Field

The present disclosure relates to an apparatus and method for assisting in driving a vehicle in entrance and exit lanes.

### Description of the Related Art

Recently, an advanced driver assistance system (ADAS) for a vehicle has been gradually developed as a technology for not only basically and simply assisting a driver in operating a brake, a handle, an accelerator pedal, and the like but also actively collecting information on an ambient environment and other vehicles, automatically determining an optimal driving route, and then driving the vehicle.

The ADAS is a key technology for implementing a smart car and includes a highway driving assistance (HAD) system (a technology automatically maintaining a distance between vehicles), a blind-spot detection (BSD) system (a technology for detecting nearby vehicles while the vehicle travels reversely and raising an alarm), an automatic emergency braking (AEB) system (a technology for operating a braking system when a driver cannot recognize a front vehicle), a lane departure warning system (LDWS), a lane-keeping assist system (LKAS) (a technology for compensating for a lane departure without turning on a turn signal lamp), an advanced smart cruise control (ASCC) (a technology for driving a vehicle at a preset constant velocity while maintaining a distance between the vehicles), a traffic jam assist (TJA) system, a parking collision-avoidance assist (PCA) system, an adaptive cruise control (ACC) system, and the like.

However, the driver cannot recognize surrounding traffic situations or driving directions of other vehicles when the vehicle enters an entrance or exit lane on the road on which the vehicle travels, which makes it difficult to determine an optimal driving route.

The driver cannot recognize an appropriate time to enter the entrance or exit lane even though the navigation system indicates a location of the entrance or exit lane on the road. As a result, there are frequent situations in which the driver waits in a congested lane even when the driver need not to wait or in which the driver needs to wait in a congested lane to enter or exit the road, but fails to do so, and later hurriedly cuts into the entrance or exit lane.

In an environment in which there are many continuous entrance and exit lanes because of the characteristics of domestic roads, the above-mentioned situations cause severe traffic congestion and frequent traffic accidents in the vicinity of the entrance and exit lanes.

### DOCUMENT OF RELATED ART

### Patent Document

JP 6946809 B2 (Sep. 21, 2021)

### SUMMARY

An object to be achieved by the present disclosure is to provide a driving assistance apparatus and a driving assistance method, which are capable of allowing a driver to optimally drive a vehicle in the vicinity of an entrance or exit lane on a road on the basis of traffic information, which is collected by means of a sensor unit, a communication unit, a navigation system, and the like of the vehicle and information on a driving route of another vehicle and a driving route of a host vehicle.

Technical problems of the present disclosure are not limited to the aforementioned technical problems, and other technical problems, which are not mentioned above, may be clearly understood by those skilled in the art from the following descriptions.

According to an aspect of the present disclosure, an apparatus for assisting in driving a vehicle in an entrance or exit lane includes: an entrance/exit lane determination unit configured to determine whether one or more entrance or exit lanes are present within a predetermined distance in a driving direction of a host vehicle; a driving route setting unit configured to set a driving route of the host vehicle on the basis of traffic information around the entrance or exit lane and driving route information of another vehicle preceding the host vehicle; and a driving route sharing unit configured to share the set driving route of the host vehicle.

In the embodiment, the entrance/exit lane determination unit may determine whether the entrance or exit lane is present on the basis of a combination of information received from a navigation system and information received from a camera.

In the embodiment, through V2X communication, the driving route setting unit may receive information on whether another vehicle enters the entrance or exit lane and receive information on whether traffic congestion occurs around the entrance or exit lane.

In the embodiment, the driving route setting unit may change the set driving route of the host vehicle on the basis of object information detected by a camera and a radar.

In the embodiment, each time the driving route of the host vehicle is set or changed, the driving route sharing unit may transmit the set driving route of the host vehicle or the changed driving route of the host vehicle to another vehicle positioned within a predetermined distance from the host vehicle.

In the embodiment, when it is determined that another vehicle is scheduled to enter the entrance or exit lane, the host vehicle is not scheduled to enter the entrance or exit lane, and there is no traffic congestion around the entrance or exit lane, the driving route setting unit may set a driving route so that the host vehicle changes the lane on which the host vehicle travels and moves ahead of another vehicle.

In the embodiment, when it is determined that another vehicle and the host vehicle are scheduled to enter the entrance or exit lane, the driving route setting unit may set a driving route so that the host vehicle keeps traveling along the lane on which the host vehicle travels.

In the embodiment, the driving route setting unit may display a screen, which indicates the set driving route of the host vehicle, on a display of the vehicle.

According to another aspect of the present disclosure, a method of assisting in driving a vehicle in an entrance or exit lane includes: determining whether one or more entrance or exit lanes are present within a predetermined distance in a driving direction of a host vehicle; setting a driving route of the host vehicle on the basis of traffic information around the entrance or exit lane and driving route information of another vehicle preceding the host vehicle; and sharing the set driving route of the host vehicle.

In the embodiment, in the determining of whether the entrance or exit lane is present, whether the entrance or exit lane is present may be determined on the basis of a combination of information received from a navigation system and information received from a camera.

In the embodiment, the setting of the driving route may include: receiving, through V2X communication, information on whether another vehicle enters the entrance or exit lane; and receiving, through the V2X communication, information on whether there is traffic congestion around the entrance or exit lane.

In the embodiment, the setting of the driving route may include changing the set driving route of the host vehicle on the basis of object information detected by a camera and a radar.

In the embodiment, the sharing of the set driving route of the host vehicle with another vehicle may include transmitting a set driving route of the host vehicle or a changed driving route of the host vehicle to another vehicle positioned within a predetermined distance from the host vehicle each time the driving route of the host vehicle is set or changed.

In the embodiment, in the setting of the driving route, a driving route may be set so that the host vehicle changes the lane on which the host vehicle travels and moves ahead of another vehicle when it is determined that another vehicle is scheduled to enter the entrance or exit lane, the host vehicle is not scheduled to enter the entrance or exit lane, and there is no traffic congestion around the entrance or exit lane.

In the embodiment, in the setting of the driving route, a driving route may be set so that the host vehicle keeps traveling along the lane on which the host vehicle travels when it is determined that another vehicle and the host vehicle are scheduled to enter the entrance or exit lane.

In the embodiment, the setting of the driving route may include displaying a screen, which indicates the set driving route of the host vehicle, on a display of the vehicle.

According to still another aspect of the present disclosure, an apparatus includes: a memory into which a program for assisting in driving a vehicle in an entrance or exit lane is loaded; and one or more processors configured to execute the program for assisting in driving a vehicle in an entrance or exit lane, the program being loaded into the memory, in which the program for assisting in driving a vehicle in an entrance or exit lane includes: an instruction for determining whether one or more entrance or exit lanes are present within a predetermined distance in a driving direction of a host vehicle; an instruction for setting a driving route of the host vehicle on the basis of traffic information around the entrance or exit lane and driving route information of another vehicle preceding the host vehicle; and an instruction for sharing the set driving route of the host vehicle.

In the embodiment, the instruction for setting the driving route may include: an instruction for receiving, through V2X communication, information on whether another vehicle enters the entrance or exit lane; and an instruction for receiving, through the V2X communication, information on whether there is traffic congestion around the entrance or exit lane.

According to the embodiment of the present disclosure, it is possible to reduce unnecessary waiting time and minimize traffic congestion by efficiently updating the driving route in the entrance or exit lane on the basis of the real-time traffic environment and the driving route of another vehicle.

In addition, according to the embodiment of the present disclosure, it is possible to calculate an optimal timing of entering the traveling lane in the entrance or exit lane, thereby preventing a risk of a traffic accident caused by sudden interruption.

In addition, according to the embodiment of the present disclosure, the vehicle may travel by automatically determining the optimal driving route even in the section in which the entrance lanes or the exit lanes are continuously positioned.

In addition, according to the embodiment of the present disclosure, it is possible to collect data related to the driving route of the vehicle in the entrance or exit lane, thereby providing an advanced navigation system capable of more efficiently guiding the route.

The various beneficial advantages and effects of the present disclosure are not limited to the above-mentioned advantages and effects, and more various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view illustrating a configuration of a vehicle for which an apparatus for assisting in driving a vehicle in an entrance or exit lane according to an embodiment of the present disclosure;

FIG. 2 is a block diagram illustrating detailed functions of the apparatus for assisting in driving a vehicle in an entrance or exit lane according to the present disclosure;

FIG. 3 is a view illustrating a state in which a screen indicating a driving route of a host vehicle set by a driving route setting unit is displayed on a display according to the embodiment of the present disclosure;

FIGS. 4A and 4B are views illustrating a first scenario in which the apparatus for assisting in driving a vehicle in an entrance or exit lane sets a driving route;

FIGS. 5A and 5B are views illustrating a second scenario in which the apparatus for assisting in driving a vehicle in an entrance or exit lane sets a driving route;

FIGS. 6A and 6B are views illustrating a third scenario in which the apparatus for assisting in driving a vehicle in an entrance or exit lane sets a driving route;

FIGS. 7A and 7B are views illustrating a fourth scenario in which the apparatus for assisting in driving a vehicle in an entrance or exit lane sets a driving route; and

FIG. 8 is a flowchart illustrating an operation of the apparatus for assisting in driving a vehicle in an entrance or exit lane according to the embodiment of the present disclosure.

### DETAILED DESCRIPTION OF THE EMBODIMENT

Hereinafter, an exemplary embodiment of the present disclosure will be described in detail with reference to the accompanying drawings. Detailed descriptions of publicly known functions and configurations will be omitted when it is determined that the detailed descriptions may unnecessarily obscure the subject matter of the present disclosure. Further, it should be noted that the following descriptions are provided for explaining the exemplary embodiment of the present disclosure and the present disclosure is not limited thereto.

The terms used in the present disclosure are used only for the purpose of describing particular embodiments but are not intended to limit the present disclosure. For example, a constituent element expressed in the singular form needs to be understood as a concept including a plurality of constituent elements unless the context clearly indicates that the constituent element is singular. It should be understood that the term “and/or” used in the present disclosure encompasses all possible combinations of one or more of the enumerated items. The terms “including” and “having” used in the present disclosure are intended to designate the existence of characteristics, numbers, steps, operations, constituent elements, and components described in the present disclosure or a combination thereof, and the use of these terms is not intended to exclude a possibility of the existence or addition of one or more other characteristics, numbers, steps, operations, constituent elements, and components, or a combination thereof.

In the embodiment of the present disclosure, the term “unit,” “part,” “module,” or the like means a functional part that performs at least one function or operation, and the “unit,” “part,” “module,” or the like may be implemented by hardware, software, or a combination of hardware and software. In addition, the term “plurality of units,” “plurality of parts,” or “plurality of modules” may be integrated into at least one software module and implemented by at least one processor, except for “a plurality of units,” “a plurality of parts,” or “a plurality of modules” that needs to be implemented by particular hardware.

Further, unless otherwise defined, all terms used in the present disclosure, including technical or scientific terms, have the same meaning as commonly understood by those skilled in the art to which the present disclosure pertains. It should be noted that the terms such as those defined in a commonly used dictionary should be interpreted as having meanings consistent with meanings in the context of related technologies and should not be interpreted as being excessively restrictive or expansive unless otherwise explicitly defined in the present disclosure.

Hereinafter, an apparatus and method for assisting in driving a vehicle in entrance and exit lanes according to the present disclosure will be described in detail with reference to the drawings.

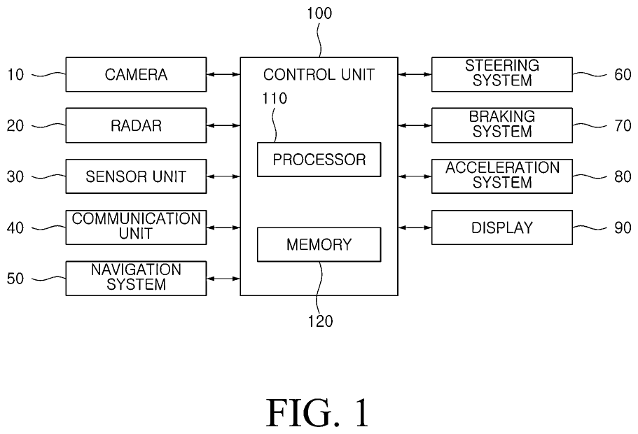

FIG. 1 is a view illustrating a configuration of a vehicle for which an apparatus for assisting in driving a vehicle in an entrance or exit lane according to an embodiment of the present disclosure.

With reference to FIG. 1, a vehicle may include a camera 10, a radar 20, a sensor unit 30, a communication unit 40, a navigation system 50, a steering system 60, a braking system 70, an acceleration system 80, a display 90, a control unit 100, and the like.

The control unit 100 may control an overall operation of the vehicle. The control unit 100 may be connected to and communicate with the camera 10, the radar 20, the sensor unit 30, the communication unit 40, and the navigation system 50 and receive information on surrounding environments of the vehicle, traffic congestion situation, a driving route of another vehicle, and the like.

In addition, the control unit 100 may be connected to and communicate with the steering system 60, the braking system 70, and the acceleration system 80 and control the traveling of the vehicle in accordance with a process defined by an ADAS. In addition, the control unit 100 may also be electrically connected to other electronic devices of the vehicle.

The camera 10, the radar 20, and the sensor unit 30 may respectively include controllers (electronic control units (ECU)). The control unit 100 may be implemented as an integrated controller including the controller of the camera 10, the controller of the radar 20, and the controller of the sensor unit 30.

The camera 10 may capture images of objects in front of the vehicle and identify other vehicles, pedestrians, cyclists, lanes, road signs, and the like. In addition, the camera 10 may identify road structures such as roadway medians, guardrails, and the like. In the embodiment of the present disclosure, the camera may determine whether an entrance or exit lane is positioned forward of the vehicle on the basis of the identified road structure.

The camera 10 may include a plurality of lenses and an image sensor. The image sensor may include a plurality of photodiodes configured to convert light into electrical signals. The plurality of photodiodes may be disposed in a two-dimensional matrix.

The camera 10 may be electrically connected to the control unit 100. For example, the camera 10 may be connected to the control unit 100 through a communication network NT for a vehicle, connected to the control unit 100 through a hard wire, or connected to the control unit 100 through a printed circuit board (PCB).

The camera 10 may transfer front image data of the vehicle to the control unit 100.

The radar 20 may include a front radar and a corner radar and acquire relative positions, relative velocities, and the like of objects (e.g., other vehicles, pedestrians, cyclists, etc.) at the periphery of the vehicle.

The radar 20 may be connected to the control unit 100 through the communication network NT for a vehicle, the hard wire, or the printed circuit board.

The radar 20 may transfer radar data to the control unit 100. In the embodiment of the present disclosure, the radar may be implemented as a lidar.

The sensor unit 30 may acquire motion data of the vehicle. For example, the sensor unit 30 may include a velocity sensor configured to detect a velocity of a wheel, an acceleration sensor configured to detect lateral and longitudinal accelerations of the vehicle, a yaw rate sensor configured to detect a change in angular velocity of the vehicle, a gyro sensor configured to detect a gradient of the vehicle, a steering angle sensor configured to detect a rotation and a steering angle of a steering wheel, and/or a torque sensor configured to detect steering torque of the steering wheel. The motion data may include a velocity, a longitudinal acceleration, a lateral acceleration, a steering angle, steering torque, a driving direction, a yaw rate, and/or a gradient of the vehicle.

The communication unit 40 may perform communication between the host vehicle and peripheral vehicles or perform wireless communication with a server that may provide traffic accident information. The communication unit 40 collects traffic accident information while communicating with the server in response to a request of the control unit 100 and provides the collected traffic accident information to the control unit 100.

The communication unit 40 may include at least any one of a transmitting antenna, a receiving antenna, a radio frequency (RF) circuit, and an RF element for implementing various types of communication protocols in order to perform communication. The communication unit 40 may perform short-range communication, GPS signal reception, V2X communication, optical communication, broadcast transmission and reception, and intelligent transport system (ITS) communication functions.

According to the embodiment of the present disclosure, the communication unit 40 may support other functions in addition to the above-mentioned functions or may not support some of the above-mentioned functions.

In the embodiment of the present disclosure, the communication unit 40 may support the short-range communication by using at least one of Bluetooth, radio frequency identification (RFID), infrared data association (IrDA), ultra-wideband (UWB), ZigBee, near-field communication (NFC), wireless-fidelity (Wi-Fi), Wi-Fi Direct, and wireless universal serial bus (Wireless USB) technologies.

In the embodiment of the present disclosure, the communication unit 40 may form a short-range wireless area network to perform the short-range communication between the vehicle and at least one external device. The communication unit 40 may include a module for supporting wireless communication between the vehicle and the server (V2I: Vehicle to Infra), other vehicles (V2V: Vehicle to Vehicle), or pedestrians (V2P: Vehicle to Pedestrians), i.e., a V2X communication module. The V2X communication module may include an RF circuit capable of implementing protocols for communication (V2I) with infrastructures, communication (V2V) between vehicles, and communication (V2P) with pedestrians. With the V2X communication module, the communication unit 40 may receive a driving route information signal transmitted from another vehicle and transmit a driving route information signal of the host vehicle to another vehicle.

The communication unit 40 may include an ITS communication module that exchanges information, data, or signals with a traffic information collection device. The ITS communication module may provide the acquired information and data to the traffic information collection device. The ITS communication module may receive the information, data, or signals from the traffic information collection device. For example, the ITS communication module may receive road traffic information from the traffic information collection device and provide the road traffic information to the control unit 100 of the vehicle. For example, the ITS communication module may receive a control signal from the traffic information collection device and provide the control signal to the control unit 100 of the vehicle or a processor 110 provided in the control unit of the vehicle. According to the embodiment of the present disclosure, an overall operation of each of the modules of the communication unit 40 may be controlled by a separate processor provided in the communication unit 40. The communication unit 40 may include a plurality of processors or may not include a processor. In case that the communication unit 40 does not include a processor, the communication unit 40 may be operated under the control of the control unit 100 of the vehicle or a processor provided in another device in the vehicle.

The navigation system 50 refers to a system for providing road/traffic information and guiding an optimal route in consideration of a traffic situation and a distance from a current position to a destination. The navigation system 50 provides an occupant with map information including information on lanes, shoulders, road shapes, and roads and traffic situations on the roads. The navigation system 50 collects traffic accident information on the basis of data stored therein or by communicating with the server in response to a request of the control unit 100, and the navigation system 50 provides the traffic accident information to the control unit 100. The traffic information may include overall accident information such as information on a position on the driving route for the vehicle equipped with this system at which a traffic accident occurs, a rate of the occurrence of traffic accidents (traffic accident risk degree), types of traffic accidents, and the like. In addition, the navigation system may calculate an optimal route to a destination in consideration of a traffic situation. For example, when the driver inputs a destination by voice or by operating manipulation elements, the navigation system may identify a current position thereof and calculate an optimal route to a destination on the basis of the identified current position and data in a map memory. In this case, real-time traffic information collected over the Internet or by means of various information communication systems including a traffic information (TIM) system and a radio data system (RDS) may be considered to calculate the distance to the destination. The real-time traffic information may include congestion sections, construction sections, road blockage, and the like.

Under the control of the control unit 100, the steering system 60 may receive a target steering angle required to drive the vehicle and generate torque so that the wheel is steered by following a target following angle. In the embodiment of the present disclosure, the steering system 60 may be an electric power steering (EPS) system.

The braking system 70 may decelerate the vehicle by braking the wheel of the vehicle by controlling a brake fluid pressure to be supplied to a wheel cylinder under the control of the control unit 100.

The acceleration system 80 may control driving power of an engine by controlling engine torque or a rotational speed (RPM) of an electric motor under the control of the control unit 100.

The display 90 may be disposed in the vehicle and provide the driver with various visual information. For example, the display 90 may display a user interface indicating a vehicle, a peripheral vehicle, a lane, a driving velocity, the type of road, a limit velocity, and the like.

The control unit 100 may include the processor 110 and a memory 120.

The control unit 100 may include one or more processors 110. The one or more processors 110 included in the control unit 100 may be integrated on a single chip or physically separated. In addition, the processor 110 and the memory 120 may be implemented as a single chip.

The processor 110 may process image data of the camera 10 and front and/or lateral radar data of the radar 20. In addition, the processor 110 may generate a steering signal for controlling the steering system 60, a braking signal for controlling the braking system 70, and an acceleration signal for controlling the acceleration system 80.

For example, the processor 110 may include an image signal processor configured to process the image data of the camera 10, a digital signal processor configured to process the radar data of the radar 20, and a micro-control unit (MCU) configured to generate the steering signal, the braking signal, and the acceleration signal.

The memory 120 may store programs and/or data for allowing the processor 110 to process the image data. The memory 120 may store programs and/or data for allowing the processor 110 to process the radar data. In addition, the memory 120 may store programs and/or data for allowing the processor 110 to generate the control signal related to the configuration of the vehicle.

The memory 120 may temporarily memorize the image data received from the camera 10 and/or the radar data received from the radar 20. In addition, the memory 120 may temporarily memorize a result of processing the image data and/or the radar data by the processor 110. The memory 120 may include not only volatile memories such as an S-RAM or a D-RAM, but also non-volatile memories such as a flash memory, a read-only memory (ROM) or an erasable programmable read-only memory (EPROM).

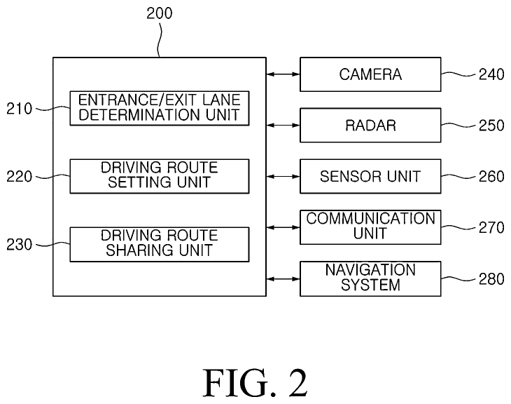

FIG. 2 is a block diagram illustrating detailed functions of an apparatus 200 for assisting in driving a vehicle in an entrance or exit lane according to the present disclosure.

The apparatus 200 for assisting in driving a vehicle in an entrance or exit lane may include the control unit 10 illustrated in FIG. 1, and the electronic component connected to the control unit 10. However, the present disclosure is not limited thereto. The apparatus 200 for assisting in driving a vehicle in an entrance or exit lane may further include an additional processor, an additional memory, other electronic components, and the like.

The apparatus 200 for assisting in driving a vehicle in an entrance or exit lane may be connected to and communicate with a camera 240, a radar 250, a sensor unit 260, a communication unit 270, and a navigation system 280. The camera 240, the radar 250, the sensor unit 260, the communication unit 270, and the navigation system 280 in FIG. 2 may be respectively identical in configurations to the camera 10, the radar 20, the sensor unit 30, the communication unit 40, and the navigation system 50 of the vehicle illustrated in FIG. 1. However, the present disclosure is not limited thereto. The apparatus 200 for assisting in driving a vehicle in an entrance or exit lane may be constituted by separate devices.

As illustrated in FIG. 2, the apparatus 200 for assisting in driving a vehicle in an entrance or exit lane may include an entrance/exit lane determination unit 210, a driving route setting unit 220, and a driving route sharing unit 230.

The entrance/exit lane determination unit 210 determine whether an entrance or exit lane is present forward of the host vehicle when velocity information of the host vehicle received from the sensor unit 260 is lower than a predetermined velocity. In the embodiment, the entrance/exit lane determination unit 210 may determine whether the entrance or exit lane is present within a predetermined distance in a driving direction of the vehicle on the basis of position information of the host vehicle and peripheral map information received from the navigation system 280. In addition, in case that a plurality of entrance lanes or a plurality of exit lanes is present within a predetermined distance in the driving direction of the vehicle, the entrance/exit lane determination unit 210 may calculate the number of present entrance or exit lanes and assign different identification numbers to the plurality of entrance lanes or a plurality of exit lanes.

In another embodiment, in case that one of the lanes disposed at two opposite sides of a lane along which the vehicle currently travels disappears, the entrance/exit lane determination unit 210 recognizes a distant lane existing at a disappearing side or a non-disappearing side by using captured image information received from the camera 240 and calculates a vehicle approach rate, which is a rate of change at which the distant lane approaches the vehicle, or calculates a vehicle separation rate, which is a rate of change at which the distant lane moves away from the vehicle, while recognizing the distant lane within the predetermined distance. Further, the entrance/exit lane determination unit 210 may determine whether the entrance or exit lane is present forward of the vehicle on the basis of the vehicle approach rate or the vehicle separation rate.

In still another embodiment, the entrance/exit lane determination unit 210 may determine whether the entrance or exit lane is present forward of the vehicle on the basis of a combination of the position information of the host vehicle and the peripheral map information received from the navigation system 280 and the captured image information received from the camera 240.

In addition, the entrance/exit lane determination unit 210 may determine whether the lane along which the vehicle currently travels is a lane connected to the entrance or exit lane on the basis of the information of the navigation system 280 and/or the captured image information of the camera 240.

When the entrance/exit lane determination unit 210 determines that one or more entrance or exit lanes are present forward of the vehicle, the driving route setting unit 220 may acquire traffic situation information in the vicinity of the one or more entrance or exit lanes from the traffic information collection device by means of the communication unit 270 and/or the navigation system 280. In addition, the driving route setting unit 220 may receive driving route information of the other vehicles from the other vehicles preceding the host vehicle through the V2X communication.

On the basis of the traffic situation information and the driving route information of the other vehicles, the driving route setting unit 220 may set a driving route that allows the host vehicle to leave the entrance or exit lane or enter or exit the entrance or exit lane without unnecessary waiting or congestion.

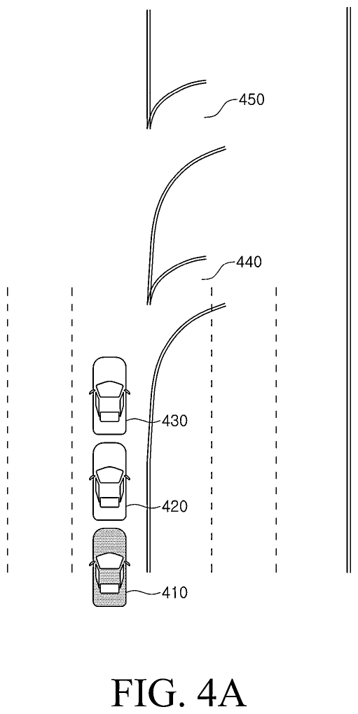

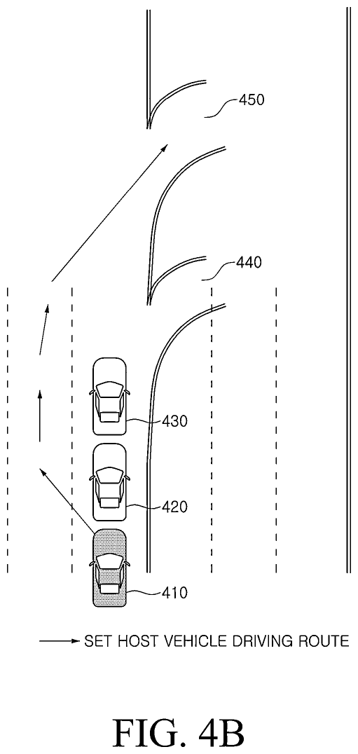

A more specific operation method in which the apparatus 200 for assisting in driving a vehicle in an entrance or exit lane sets the driving route of the vehicle by means of the driving route setting unit 220 will be described in detail with reference to examples of scenarios illustrated in FIGS. 4 to 7.

In the embodiment of the present disclosure, the driving route setting unit 220 may change the set driving route on the basis of object information detected by the camera 240 and the radar 250. For example, in case that object information related to the plurality of vehicles is detected in the set driving route, the driving route setting unit 220 may change the set driving route to allow the vehicle to travel along the route in which no vehicle object is present. That is, when the object information related to the plurality of vehicles is detected in the lane to be changed in case that the driving route is set so that the lane is changed and the vehicle travels along the changed lane, the driving route setting unit 220 may change the set driving route so that the vehicle keeps traveling along the current lane.

The driving route sharing unit 230 may share the driving route of the host vehicle set by the driving route setting unit 220 with the other vehicles through the V2X communication by using the communication unit 270. In the embodiment of the present disclosure, in case that the driving route of the host vehicle is set or the set driving route of the host vehicle is changed by the driving route setting unit 220, the driving route sharing unit 230 may transmit the set or changed driving route of the host vehicle to the other vehicles within a predetermined distance from the host vehicle. In another embodiment of the present disclosure, in case that the driving route sharing unit 230 receives, from the other vehicle through the communication unit 270, a signal for requesting the driving route of the host vehicle, the driving route sharing unit 230 may transmit the set driving route to the other vehicle in response to the request.

In addition, the driving route sharing unit 230 may transmit the set driving route to a system for collecting navigation system data, and the system may collect driving route setting data, and the driving route setting data may be used to provide an advanced navigation system or the like capable of more efficiently guiding the driving route.

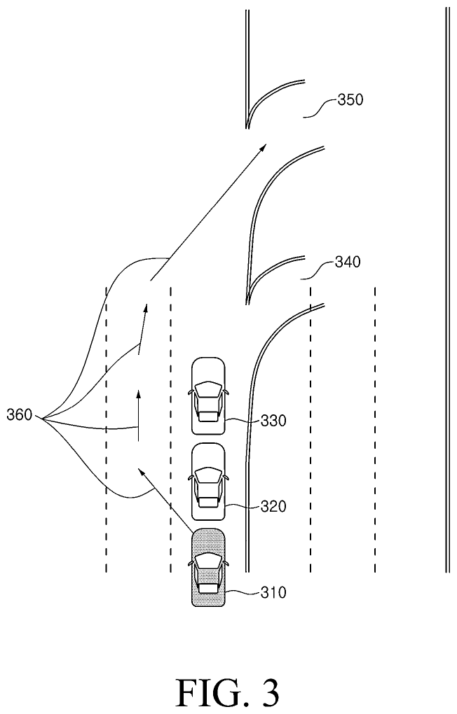

In the embodiment of the present disclosure, the apparatus 200 for assisting in driving a vehicle in an entrance or exit lane may display, on the display 90, a screen indicating the driving route of the host vehicle set by the driving route setting unit 220. As exemplarily illustrated in FIG. 3, the screen indicating the set driving route of the host vehicle may include objects indicating a host vehicle 310, the other vehicles 320 and 330, and entrance and exit lanes 340 and 350 and also display arrow-shaped indicators 360 indicating a preset driving route of the host vehicle. The driver may recognize the set driving route of the host vehicle by means of the indicators 360 displayed on the screen on the display 90 and thus control the vehicle so that the vehicle travels along the driving route.

In addition, in another embodiment of the present disclosure, the apparatus 200 for assisting in driving a vehicle in an entrance or exit lane may directly control the steering system 60, the braking system 70, and the acceleration system 80 so that the vehicle may autonomously travel along the driving route set by the driving route setting unit 220.

FIGS. 4A and 4B illustrate a first scenario in which the apparatus 200 for assisting in driving a vehicle in an entrance or exit lane sets a driving route.

As illustrated in FIG. 4A, in the first scenario, a first exit lane 440 and a second exit lane 450 are continuously positioned on a driving route of a host vehicle 410, and first and second vehicles 420 and 430 preceding the host vehicle 410 travel along the same lane as the host vehicle 410. In addition, in the first scenario, it is assumed that the host vehicle 410 is scheduled to exit the road through the second exit lane 450, and both the first and second vehicles 420 and 430 are scheduled to exit the road through the first exit lane 440.

In the first scenario, the apparatus 200 for assisting in driving a vehicle in an entrance or exit lane acquires traffic information around the first and second exit lanes 440 and 450 and driving route information of the first and second vehicles 420 and 430 by means of the communication unit 270 and the navigation system 280.

In case that the apparatus 200 for assisting in driving a vehicle in an entrance or exit lane determines, on the basis of the above-mentioned information, that it is difficult for the host vehicle to exit the road through the second exit lane 450 by changing the lanes because of traffic congestion between a rear end region of the first exit lane 440 and a front end region of the second exit lane 450, i.e., in a region between the first exit lane 440 and the second exit lane 450, the apparatus 200 for assisting in driving a vehicle in an entrance or exit lane may set the driving route so that the host vehicle keeps traveling along the current lane.

In addition, in case that the apparatus 200 for assisting in driving a vehicle in an entrance or exit lane identifies that no traffic congestion is present in the region between the first exit lane 440 and the second exit lane 450 and both the first and second vehicles 420 and 430 are scheduled to exit the road through the first exit lane 440, the apparatus 200 for assisting in driving a vehicle in an entrance or exit lane determines that it is advantageous for the host vehicle to exit the road through the second exit lane 450 by changing the lanes. Therefore, as illustrated in FIG. 4B, the apparatus 200 for assisting in driving a vehicle in an entrance or exit lane may set a driving route so that the host vehicle 410 changes the lanes, moves ahead of the first and second vehicles 420 and 430, and then exits the road through the second exit lane 450.

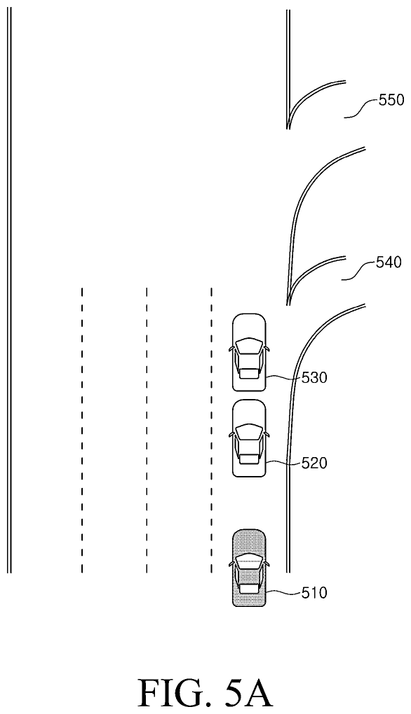

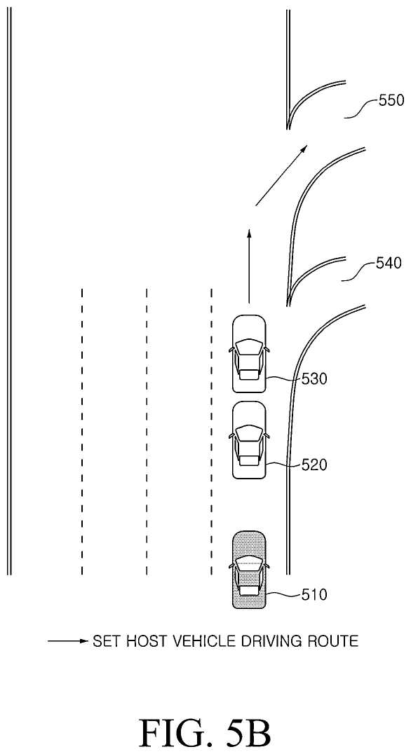

FIGS. 5A and 5B illustrate a second scenario in which the apparatus for assisting in driving a vehicle in an entrance or exit lane sets a driving route.

As illustrated in FIG. 5A, in the second scenario, a first exit lane 540 and a second exit lane 550 are continuously positioned on a driving route of a host vehicle 510, and first and second vehicles 520 and 530 preceding the host vehicle 510 travel along the same lane as the host vehicle 510. In addition, in the second scenario, it is assumed that all the host vehicle 510, the first vehicle 520, and the second vehicle 530 are scheduled to exit the road through the second exit lane 550.

In the second scenario, the apparatus 200 for assisting in driving a vehicle in an entrance or exit lane acquires driving route information of the first and second vehicles 520 and 530 by means of the communication unit 270. When the apparatus 200 for assisting in driving a vehicle in an entrance or exit lane identifies, on the basis of the acquired driving route information of the first and second vehicles 520 and 530, that both the first and second vehicles 520 and 530 are scheduled to enter the second exit lane 550, like the host vehicle 510, the apparatus 200 for assisting in driving a vehicle in an entrance or exit lane may set a driving route so that the host vehicle keeps traveling along the current lane, as illustrated in FIG. 5B.

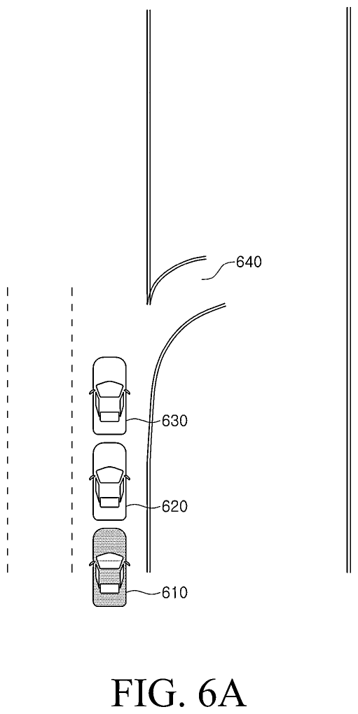

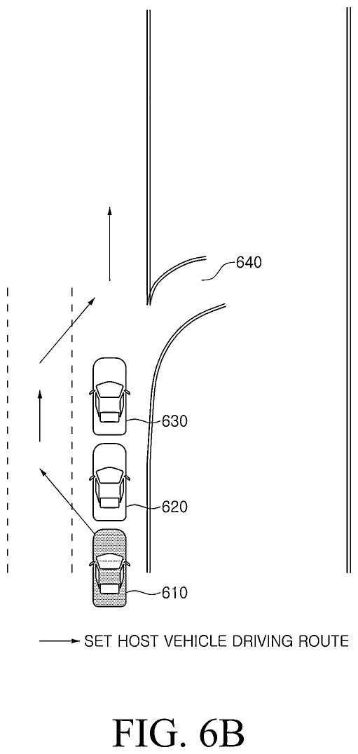

FIGS. 6A and 6B illustrate a third scenario in which the apparatus 200 for assisting in driving a vehicle in an entrance or exit lane sets a driving route.

As illustrated in FIG. 6A, in the third scenario, a single exit lane 640 is positioned on a driving route of a host vehicle 610, and first and second vehicles 620 and 630 preceding the host vehicle 610 travel along the same lane as the host vehicle 610. In addition, in the third scenario, it is assumed that the host vehicle 610 is not scheduled to exit the road through the exit lane 640 and both the first and second vehicles 620 and 630 are scheduled to exit the road through the exit lane 640.

In the third scenario, the apparatus 200 for assisting in driving a vehicle in an entrance or exit lane may acquire driving route information of the first and second vehicles 620 and 630 by means of the communication unit 270 and identify, on the basis of the acquired driving route information of the first and second vehicles 620 and 630, that the first and second vehicles 620 and 630 are scheduled to enter the exit lane 640. Next, the apparatus 200 for assisting in driving a vehicle in an entrance or exit lane may request traffic information around the exit lane 640 from the traffic information collection device by means of the communication unit 270 and/or the navigation system 280 and receive the traffic information. In case that the apparatus 200 for assisting in driving a vehicle in an entrance or exit lane determines, on the basis of the traffic information, that there is no traffic congestion in the rear end region of the exit lane, the apparatus 200 for assisting in driving a vehicle in an entrance or exit lane may set a driving route of the host vehicle 610 so that the host vehicle 610 changes the lands and moves ahead of the first and second vehicles 620 and 630, as illustrated in FIG. 6B.

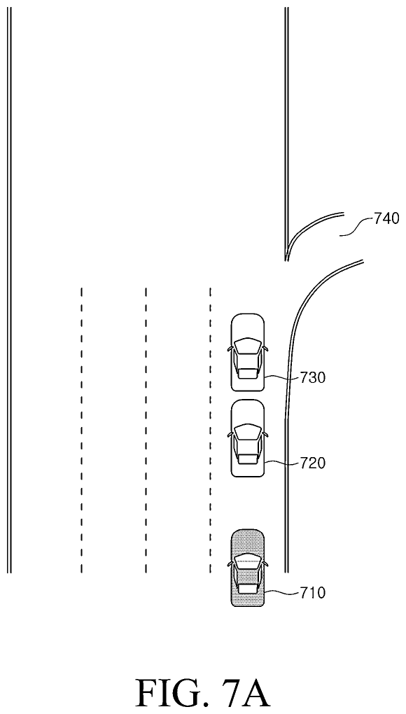

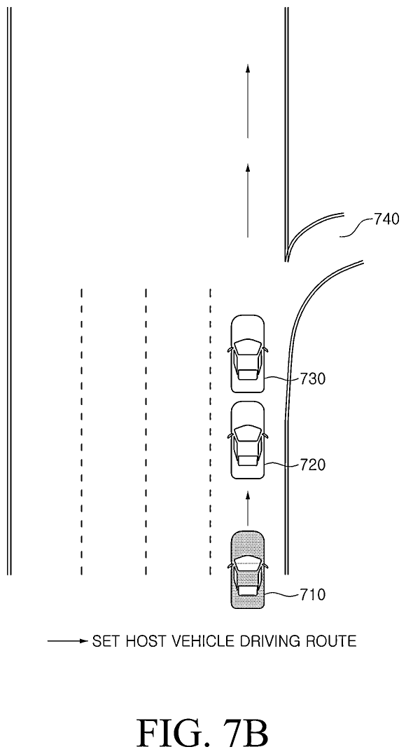

FIGS. 7A and 7B illustrate a fourth scenario in which the apparatus 200 for assisting in driving a vehicle in an entrance or exit lane sets a driving route.

As illustrated in FIG. 7A, in the fourth scenario, an exit lane 740 is positioned on a driving route of a host vehicle 710, and first and second vehicles 720 and 730 preceding the host vehicle 710 travel along the same lane as the host vehicle 710. In addition, in the fourth scenario, it is assumed that all the host vehicle 710, the first vehicle 720, and the second vehicle 730 are not scheduled to exit the road through the exit lane 740.

In the fourth scenario, the apparatus 200 for assisting in driving a vehicle in an entrance or exit lane acquires driving route information of the first and second vehicles 720 and 730 by means of the communication unit 270. When the apparatus 200 for assisting in driving a vehicle in an entrance or exit lane identifies, on the basis of the acquired driving route information of the first and second vehicles 720 and 730, that both the first and second vehicles 720 and 730 are not scheduled to enter the exit lane 740, like the host vehicle 710, the apparatus 200 for assisting in driving a vehicle in an entrance or exit lane may set a driving route of the host vehicle 710 so that the host vehicle keeps traveling in the current lane, as illustrated in FIG. 7B.

The operations in which the apparatus 200 for assisting in driving a vehicle in an entrance or exit lane sets the driving routes of the vehicle in accordance with the scenarios have been described with reference to FIGS. 4 to 7. However, the present disclosure is not limited thereto. The apparatus 200 for assisting in driving a vehicle in an entrance or exit lane may set driving routes of the vehicle in accordance with more various scenarios that are not illustrated in the drawings.

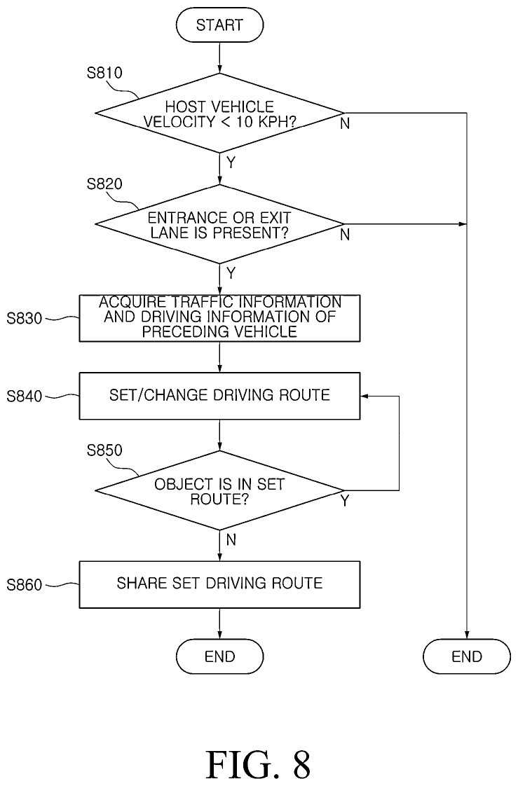

FIG. 8 is a flowchart illustrating an operation of the apparatus 200 for assisting in driving a vehicle in an entrance or exit lane according to the embodiment of the present disclosure.

First, the entrance/exit lane determination unit 210 determines whether a velocity of the host vehicle received from the sensor unit 260 is lower than a predetermined velocity, e.g., 10 kph (S810).

In case that the velocity of the host vehicle is lower than the predetermined velocity, the entrance/exit lane determination unit 210 determines whether an entrance or exit lane is present forward of a driving route of the host vehicle on the basis of position information of the host vehicle and peripheral map information received from the navigation system 280 and/or captured image information of the camera 240 (S820).

In case that it is determined that the entrance or exit lane is present forward of the vehicle, the driving route setting unit 220 acquires traffic information around the entrance or exit lane and driving routes of preceding other vehicles from the communication unit 270 and/or the navigation system 280 (S830).

Next, on the basis of the traffic information and the driving route information of another vehicle acquired in step S830, the driving route setting unit 220 sets a driving route along which the host vehicle leaves the entrance or exit lane or enters or exits the entrance or exit lane without unnecessary congestion (S840).

Next, the driving route setting unit 220 determines whether an object is detected in the set driving route on the basis of signals from the camera 240 and/or the radar 250 (S850). In this case, in case that it is determined that the object is detected in the set driving route, the driving route setting unit 220 may perform step S840 again and change the set driving route.

In case that it is determined that no object is detected in the set driving route in step S850, the driving route sharing unit 230 transfers the set driving route information of the host vehicle to another vehicle (S860).

Although the embodiments of the present disclosure have been described in detail with reference to the accompanying drawings, the present disclosure is not limited thereto and may be embodied in many different forms without departing from the technical concept of the present disclosure. Therefore, the embodiments disclosed in the present disclosure are provided for illustrative purposes only but not intended to limit the technical spirit of the present disclosure. The scope of the technical spirit of the present disclosure is not limited thereby. Therefore, it should be understood that the above-described embodiments are illustrative in all aspects and do not limit the present disclosure. The protective scope of the present disclosure should be construed based on the following claims, and all the technical spirit in the equivalent scope thereto should be construed as falling within the scope of the present disclosure.

What is claimed is:

1. An apparatus for assisting in driving a vehicle in an entrance or exit lane, the apparatus comprising:
an entrance/exit lane determination unit configured to determine whether one or more entrance or exit lanes are present within a predetermined distance in a driving direction of a host vehicle;
a driving route setting unit configured to set a driving route of the host vehicle on the basis of traffic information around the entrance or exit lane and driving route information of another vehicle preceding the host vehicle; and
a driving route sharing unit configured to share the set driving route of the host vehicle.

2. The apparatus of claim 1, wherein the entrance/exit lane determination unit determines whether the entrance or exit lane is present on the basis of a combination of information received from a navigation system and information received from a camera.

3. The apparatus of claim 1, wherein through V2X communication, the driving route setting unit receives information on whether another vehicle enters the entrance or exit lane and receives information on whether traffic congestion occurs around the entrance or exit lane.

4. The apparatus of claim 3, wherein the driving route setting unit changes the set driving route of the host vehicle on the basis of object information detected by a camera and a radar.

5. The apparatus of claim 4, wherein each time the driving route of the host vehicle is set or changed, the driving route sharing unit transmits the set driving route of the host vehicle or the changed driving route of the host vehicle to another vehicle positioned within a predetermined distance from the host vehicle.

6. The apparatus of claim 3, wherein when it is determined that another vehicle is scheduled to enter the entrance or exit lane, the host vehicle is not scheduled to enter the entrance or exit lane, and there is no traffic congestion around the entrance or exit lane, the driving route setting unit sets a driving route so that the host vehicle changes the lane on which the host vehicle travels and moves ahead of another vehicle.

7. The apparatus of claim 3, wherein when it is determined that another vehicle and the host vehicle are scheduled to enter the entrance or exit lane, the driving route setting unit sets a driving route so that the host vehicle keeps traveling along the lane on which the host vehicle travels.

8. The apparatus of claim 1, wherein the driving route setting unit displays a screen, which indicates the set driving route of the host vehicle, on a display of the vehicle.

9. A method of assisting in driving a vehicle in an entrance or exit lane, the method comprising:
determining whether one or more entrance or exit lanes are present within a predetermined distance in a driving direction of a host vehicle;
setting a driving route of the host vehicle on the basis of traffic information around the entrance or exit lane and driving route information of another vehicle preceding the host vehicle; and
sharing the set driving route of the host vehicle.

10. The method of claim 9, wherein in the determining of whether the entrance or exit lane is present, whether the entrance or exit lane is present is determined on the basis of a combination of information received from a navigation system and information received from a camera.

11. The method of claim 9, wherein the setting of the driving route comprises:
receiving, through V2X communication, information on whether another vehicle enters the entrance or exit lane; and
receiving, through the V2X communication, information on whether there is traffic congestion around the entrance or exit lane.

12. The method of claim 11, wherein the setting of the driving route comprises changing the set driving route of the host vehicle on the basis of object information detected by a camera and a radar.

13. The method of claim 12, wherein the sharing of the set driving route of the host vehicle with another vehicle comprises transmitting a set driving route of the host vehicle or a changed driving route of the host vehicle to another vehicle positioned within a predetermined distance from the host vehicle each time the driving route of the host vehicle is set or changed.

14. The method of claim 11, wherein in the setting of the driving route, a driving route is set so that the host vehicle changes the lane on which the host vehicle travels and moves ahead of another vehicle when it is determined that another vehicle is scheduled to enter the entrance or exit lane, the host vehicle is not scheduled to enter the entrance or exit lane, and there is no traffic congestion around the entrance or exit lane.

15. The method of claim 11, wherein in the setting of the driving route, a driving route is set so that the host vehicle keeps traveling along the lane on which the host vehicle travels when it is determined that another vehicle and the host vehicle are scheduled to enter the entrance or exit lane.

16. The method of claim 11, wherein the setting of the driving route comprises displaying a screen, which indicates the set driving route of the host vehicle, on a display of the vehicle.

17. An apparatus comprising:
a memory into which a program for assisting in driving a vehicle in an entrance or exit lane is loaded; and
one or more processors configured to execute the program for assisting in driving a vehicle in an entrance or exit lane, the program being loaded into the memory,
wherein the program for assisting in driving a vehicle in an entrance or exit lane comprises:
an instruction for determining whether one or more entrance or exit lanes are present within a predetermined distance in a driving direction of a host vehicle;
an instruction for setting a driving route of the host vehicle on the basis of traffic information around the entrance or exit lane and driving route information of another vehicle preceding the host vehicle; and
an instruction for sharing the set driving route of the host vehicle.

18. The apparatus of claim 17, wherein the instruction for setting the driving route comprises:
an instruction for receiving, through V2X communication, information on whether another vehicle enters the entrance or exit lane; and
an instruction for receiving, through the V2X communication, information on whether there is traffic congestion around the entrance or exit lane.
